(19) United States
(12) Patent Application Publication
(10) Pub. No.: US 2015/0156017 A1
(43) Pub. Date: Jun. 4, 2015

(54) Works Transmitting Process and System

(71) Applicants: Kwok fong Wong, Heshan (CN); Pui yi Ching, Heshan (CN)

(72) Inventors: Kwok fong Wong, Heshan (CN); Pui yi Ching, Heshan (CN)

(73) Assignee: WWTT Technology China, Heshan, Guangdong (CN)

(21) Appl. No.: 14/000,211

(22) PCT Filed: Jan. 25, 2013
(86) PCT No.: PCT/CN2013/071005

§ 371 Date: Aug. 17, 2013

(30) Foreign Application Priority Data
Nov. 7, 2012 (CN) 201210438176.6

(51) Int. Cl. H04L 9/08

(52) U.S. Cl. CPC H04L 9/0838

(57) ABSTRACT

This invention discloses a type of works transmitting process and system, which belongs to the field of communication technology. The process comprises: works transmitting terminal exchanges secret key with works receiving terminal through FingerQ Platform; the works transmitting terminal transmits works to the FingerQ Platform, which encrypts the works, acquires and transmits decrypted works to said works receiving terminal. The system comprises: works transmitting terminal and FingerQ Platform. In this invention, works transmitting terminal exchanges secret key with works receiving terminal through FingerQ Platform, which encrypts the works at works transmitting terminal and transmits encrypted works to works receiving terminal, so that the works will not easily be acquired by a third party; moreover acquired works is encrypted that the works can be well protected with high degree of safety.

### TECHNICAL FIELD

The invention relates to the field of communication technology, particularly to a type of works transmitting process and system.

### BACKGROUND ART

With the development of economy and technology, various works in all walks of life such as literary works, film and television works, artistic and architectural works, photography works, software works emerge in endlessly. Currently, when the works are produced, the creator of works can transmit the works to the grantee (the user authorized by the creator to legally make use of the works) for his/her utilization.

However, in the realization of invention, the inventor finds that current technology has at least the following problem:

In transmission of works by current technology, the creator transmits the works directly, the works will be easily acquired by a third party for copied utilization or illegal transmission, thus the transmission of works has no safety.

### SUMMARY OF THE INVENTION

To solve the problem in current technology, the embodiments of this invention provide a type of works transmitting process and system. Below is the said technical proposal:

In one aspect, a type of works transmitting process is provided, comprising:

Works transmitting terminal exchanges secret key with works receiving terminal through FingerQ Platform;

Said works transmitting terminal transmits works to said FingerQ Platform, which encrypts the works, acquires and transmits decrypted works to said works receiving terminal.

In a further aspect, a type of works transmitting system is provided, comprising: works transmitting terminal and FingerQ Platform, connection between said transmitting terminal and said FingerQ Platform;

Wherein, said transmitting terminal comprises:

Transmitting terminal secret key exchange device is used to exchange secret key with works receiving terminal through said FingerQ Platform;

Works transmitter, connecting to said transmitting terminal secret key exchange device, is used to transmit the works to said FingerQ Platform after said transmitting terminal secret key exchange device has exchanged secret key with works receiving terminal through said FingerQ Platform;

Wherein, said FingerQ Platform comprises:

Works receiver connecting to said works transmitter is used to receive the works transmitted by said works transmitter;

Works processor connecting to said works receiver is used to encrypt the works received by said works receiver, acquire and transmit encrypted works to said works receiving terminal.

The beneficial effects brought by technical proposal of this invention's embodiments comprise:

Works transmitting terminal exchanges secret key with works receiving terminal through FingerQ Platform, which encrypts the works at works transmitting terminal and transmits encrypted works to works receiving terminal, so that the works will not easily be acquired by a third party; moreover acquired works is encrypted that the works can be well protected with high degree of safety.

### DESCRIPTION OF THE DRAWINGS

In order to illustrate more clearly technical proposal of this invention's embodiments, below is a simple description of the drawings to be used in the embodiments. Obviously, the drawings in the description below are only some embodiments of this invention, for ordinary technicians in this field, without contributing creative labour, they are able to acquire other drawings on the basis of these drawings.

FIG. 1 is a flowchart of works transmitting process provided by Embodiment 1 of this invention;

FIG. 2 is a flowchart of works transmitting process provided by Embodiment 2 of this invention;

FIG. 3 is a schematic view of the first type of works transmitting system provided by Embodiment 3 of this invention;

FIG. 4 is a schematic view of the second type of works transmitting system provided by Embodiment 3 of this invention;

FIG. 5 is a schematic view of the third type of works transmitting system provided by Embodiment 3 of this invention;

FIG. 6 is a schematic view of the fourth type of works transmitting system provided by Embodiment 3 of this invention;

FIG. 7 is a schematic view of the fifth type of works transmitting system provided by Embodiment 3 of this invention.

### DETAILED DESCRIPTION OF THE PREFERRED EMBODIMENTS

To make clearer the purpose, technical proposal and advantages of the invention, below is a more detailed description of this invention in combination with the accompanying figures and embodiments.

### Embodiment 1

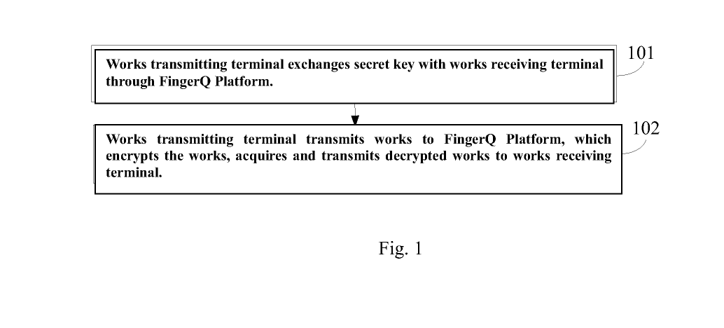

As shown in FIG. 1, Embodiment 1 of this invention provides a type of works transmitting process, comprising:

101: Works transmitting terminal exchanges secret key with works receiving terminal through FingerQ Platform.

102: Works transmitting terminal transmits the works to FingerQ Platform, which encrypts the works, acquires and transmits encrypted works to works receiving terminal.

Preferably, works transmitting terminal exchanges secret key with works receiving terminal through FingerQ Platform, comprising:

Works transmitting terminal extracts user's fingerprint information corresponding to works transmitting terminal, acquires fingerprinting public key and fingerprinting private key of works transmitting terminal according to user's fingerprint information corresponding to works transmitting terminal;

Through FingerQ Platform, works transmitting terminal transmits to works receiving terminal secret key exchange request and fingerprinting public key of works transmitting terminal;

Works transmitting terminal receives confirmation message of secret key exchange transmitted by works receiving terminal through FingerQ Platform and fingerprinting public key of works receiving terminal.

Preferably, works transmitting terminal transmits the works to FingerQ Platform, which encrypts the works, acquires and transmits encrypted works to works receiving terminal:

Works transmitting terminal transmits the works to FingerQ Platform, which makes use of fingerprinting public key of works receiving terminal to encrypt the works, acquires and transmits the works with public key encryption to works receiving terminal.

Preferably, works transmitting terminal transmits the works to FingerQ Platform, which makes use of fingerprinting public key of works receiving terminal to encrypt the works, acquires and transmits the works with public key encryption to works receiving terminal, comprising:

Works transmitting terminal makes use of fingerprinting private key of works transmitting terminal to encrypt the works, acquires the works with private key encryption;

Works transmitting terminal transmits the works with private key encryption to FingerQ Platform, which makes use of public key of works receiving terminal to encrypt the works with private key encryption, acquires the works with public and private key encryption and transmits the works to works receiving terminal.

Preferably, FingerQ Platform encrypts the works, acquires and transmits encrypted works to works receiving terminal, also comprising:

Works receiving terminal receives and decrypt the works with encryption, acquires and displays decrypted works.

For the said works transmitting process in the embodiment of this invention, works transmitting terminal exchanges secret key with works receiving terminal through FingerQ Platform, which encrypts the works at works transmitting terminal and transmits encrypted works to works receiving terminal, so that the works will not easily be acquired by a third party; moreover acquired works is encrypted that the works can be well protected with high degree of safety.

It needs to be noted that, the said works transmitting process in the embodiment of this invention can be applied in terminals such as computer, and also in mobile terminals such as mobile phone, which prescribes no limit to this.

### Embodiment 2

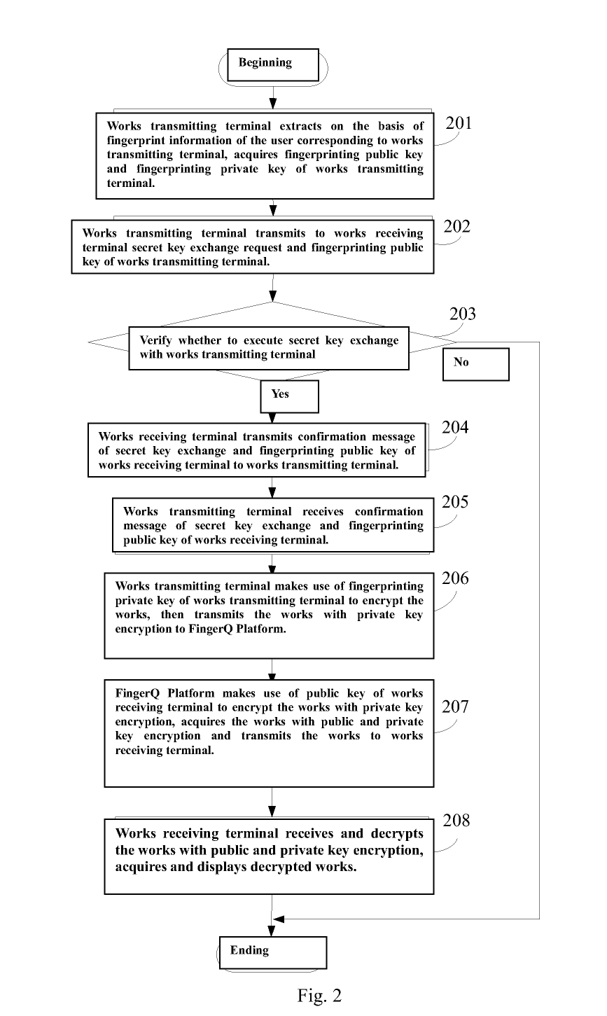

As shown in FIG. 2, Embodiment 2 of this invention provides a type of works transmitting process, comprising:

201: Works transmitting terminal extracts user's fingerprint information corresponding to works transmitting terminal, acquires fingerprinting public key and fingerprinting private key of works transmitting terminal according to user's fingerprint information corresponding to works transmitting terminal.

Wherein, the users corresponding to works transmitting terminal comprise the creator of works and the creator's deputy who have the right of disposition on the works.

Specifically, it is possible to install transmitting terminal fingerprint sensor at works transmitting terminal, which extracts fingerprint information of the user corresponding to works transmitting terminal. In addition, it is possible to install a storer at works transmitting terminal, which stores fingerprint information of the user corresponding to works transmitting terminal, fingerprinting public and private key of works transmitting terminal.

202: Through FingerQ Platform, works transmitting terminal transmits to works receiving terminal secret key exchange request and fingerprinting public key of works transmitting terminal.

Wherein, the users corresponding to works receiving terminal comprise the grantee of works and the grantee's deputy who have the right of legal utilization of the works.

Wherein, FingerQ Platform may be terminals such as computer, mobile terminals such as laptop or the equipment which have relevant functions.

Specifically, works transmitting terminal transmits secret key exchange request and fingerprinting public key of works transmitting terminal to FingerQ Platform, which transmits to works receiving terminal secret key exchange request transmitted by works transmitting terminal and fingerprinting public key of works transmitting terminal.

In addition, specifically, after receiving secret key exchange request transmitted by works transmitting terminal and fingerprinting public key of works transmitting terminal, FingerQ Platform can store fingerprinting public key of works transmitting terminal into corresponding space of FingerQ Platform.

203: Works receiving terminal receives secret key exchange request and fingerprinting public key of works transmitting terminal, verifies whether to execute secret key exchange with works transmitting terminal; if exchange is confirmed, execute 204; otherwise, terminate the process.

Specifically, works receiving terminal can store fingerprinting public key at works transmitting terminal into the storer of works receiving terminal.

204: Through FingerQ Platform, works receiving terminal transmits to works transmitting terminal confirmation message of secret key exchange and fingerprinting public key of works receiving terminal.

Specifically, works receiving terminal transmits confirmation message of secret key exchange and fingerprinting public key of works receiving terminal to FingerQ Platform, which transmits to works transmitting terminal confirmation message of secret key exchange and fingerprinting public key of works receiving terminal transmitted by works receiving terminal.

In addition, specifically, after receiving confirmation message of secret key exchange transmitted by works receiving terminal and fingerprinting public key of works receiving terminal, FingerQ Platform can store fingerprinting public key of works receiving terminal into corresponding space of FingerQ Platform.

205: Works transmitting terminal receives confirmation message of secret key exchange transmitted by works receiving terminal and fingerprinting public key of works receiving terminal through FingerQ Platform.

Specifically, works transmitting terminal can store fingerprinting public key at works receiving terminal into the storer of works transmitting terminal.

206: Works transmitting terminal makes use of fingerprinting private key at works transmitting terminal to encrypt the works, acquires and transmits the works with private key encryption to FingerQ Platform.

207: FingerQ Platform makes use of fingerprinting public key of works receiving terminal to encrypt the works with private key encryption, acquires and transmits the works with public and private key encryption to works receiving terminal.

Specifically, if fingerprinting public key of works receiving terminal is stored in FingerQ Platform, it is possible to directly read fingerprinting public key of works receiving terminal, make use of fingerprinting public key of works receiving terminal to encrypt the works with private key encryption. If fingerprinting public key of works receiving terminal is stored in FingerQ Platform, it is possible to acquire fingerprinting public key of works receiving terminal directly from works receiving terminal, make use of it to encrypt the works with private key encryption.

208: Works receiving terminal receives the works and decrypt the works with public and private key encryption, acquires and displays decrypted works, then the process terminals.

Wherein, the operation to decrypt the works with public and private key encryption and display decrypted works can be realized either at works receiving terminal or on FingerQ Platform.

When it is realized at works receiving terminal, below are the details: works receiving terminal receives the works with public and private key encryption; works receiving terminal makes use of private key of works receiving terminal and public key of works transmitting terminal to decrypt the works with public and private key encryption, acquire and display decrypted works.

When it is realized on FingerQ Platform, below are the details: works receiving terminal receives the works with public and private key encryption; works receiving terminal decrypts the works with public and private key encryption through FingerQ Platform, acquires and displays decrypted works on FingerQ Platform. The mode to realize and display decrypted works on FingerQ Platform makes it possible to acquire works only by FingerQ Platform, which can restrict abuse of works after works receiving terminal acquires it and further protect works.

For the said works transmitting process in the embodiment of this invention, works transmitting terminal exchanges secret key with works receiving terminal through FingerQ Platform, which encrypts the works at works transmitting terminal and transmits encrypted works to works receiving terminal, so that the works will not easily be acquired by a third party; moreover acquired works is encrypted that the works can be well protected with high degree of safety.

### Embodiment 3

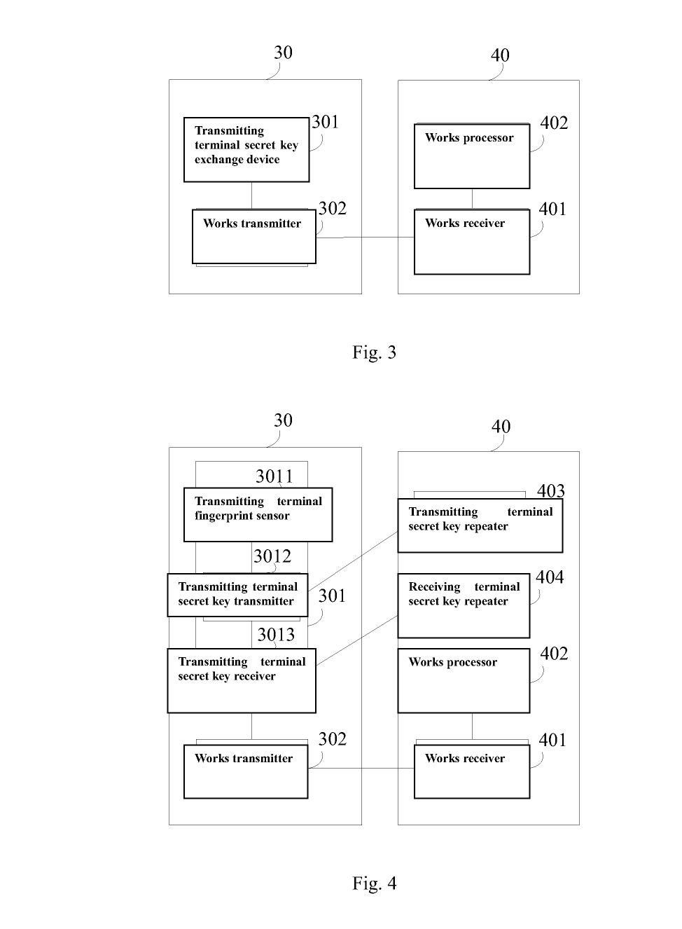

As shown in FIG. 3, Embodiment 3 of this invention provides a type of works transmitting system, comprising: works transmitting terminal 30 and FingerQ Platform 40, connection between works transmitting terminal 30 and FingerQ Platform 40;

Wherein, works transmitting terminal 30 comprises:

Transmitting terminal secret key exchange device 301 connecting to FingerQ Platform 40 is used to exchange secret key with works receiving terminal 50 through FingerQ Platform 40;

Works transmitter 302 connecting to transmitting terminal secret key exchange device 301 is used to transmit the works to FingerQ Platform 40 after transmitting terminal secret key exchange device 301 has exchanged secret key with works receiving terminal 50 through FingerQ Platform 40;

Wherein, FingerQ Platform 40 comprises:

Works receiver 401 connecting to works transmitter 302 is used to receive the works transmitted by works transmitter 302;

Works processor 402 connecting to works receiver 401 is used to encrypt the works received by works receiver 401, acquire and transmit encrypted works to works receiving terminal 50.

Preferably, as shown in FIG. 4, transmitting terminal secret key exchange device 301 comprises:

Transmitting terminal fingerprint sensor 3011 is used to extract fingerprint information of the user corresponding to works transmitting terminal 30, on the basis of the above fingerprint information, acquire fingerprinting public key and fingerprinting private key of works transmitting terminal 30;

Transmitting terminal secret key transmitter 3012 connecting to transmitting terminal fingerprint sensor 3011 is used to secret key exchange request and fingerprinting public key of works transmitting terminal 30 to FingerQ Platform 40 after transmitting terminal fingerprint sensor 3011 acquires fingerprinting public key and fingerprinting private key of works transmitting terminal 30;

Accordingly, FingerQ Platform 40 also comprises:

Transmitting terminal secret key repeater 403 connecting to transmitting terminal secret key transmitter 3012 is used to receive secret key exchange request transmitted by transmitting terminal secret key transmitter 3012 and fingerprinting public key of works transmitting terminal 30, transmit secret key exchange request transmitted by transmitting terminal secret key transmitter 3012 and fingerprinting public key of works transmitting terminal 30 to works receiving terminal 50;

Receiving terminal secret key repeater 404 connecting to works transmitting terminal 30 is used to receive confirmation message of secret key exchange transmitted by works receiving terminal 50 and fingerprinting public key of works receiving terminal 50, transmit the above information to works transmitting terminal 30;

Accordingly, transmitting terminal secret key exchange device 301 also comprises:

Transmitting terminal secret key receiver 3013, respectively connecting to works transmitter 302 and receiving terminal secret key repeater 404, is used to receive confirmation message of secret key exchange transmitted by receiving terminal secret key repeater 404 and fingerprinting public key of works receiving terminal 50;

Accordingly, works transmitter 302, specifically connecting to transmitting terminal secret key receiver 3013, is used to transmit the works to FingerQ Platform 40 after transmitting terminal secret key receiver 3013 receives confirmation message of secret key exchange transmitted by receiving terminal secret key repeater 404 and fingerprinting public key of works receiving terminal 50.

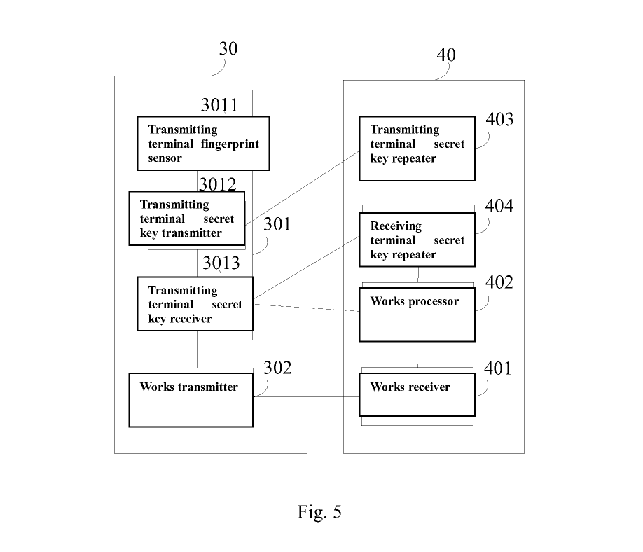

Preferably, as shown in FIG. 5, works processor 402, also connecting to receiving terminal secret key repeater 404 or transmitting terminal secret key receiver 3013, specifically makes use of fingerprinting public key of works receiving terminal 50 acquired through receiving terminal secret key repeater 404 or transmitting terminal secret key receiver 3013 to encrypt the works, so as to acquire and transmit the works with public key encryption to works receiving terminal 50.

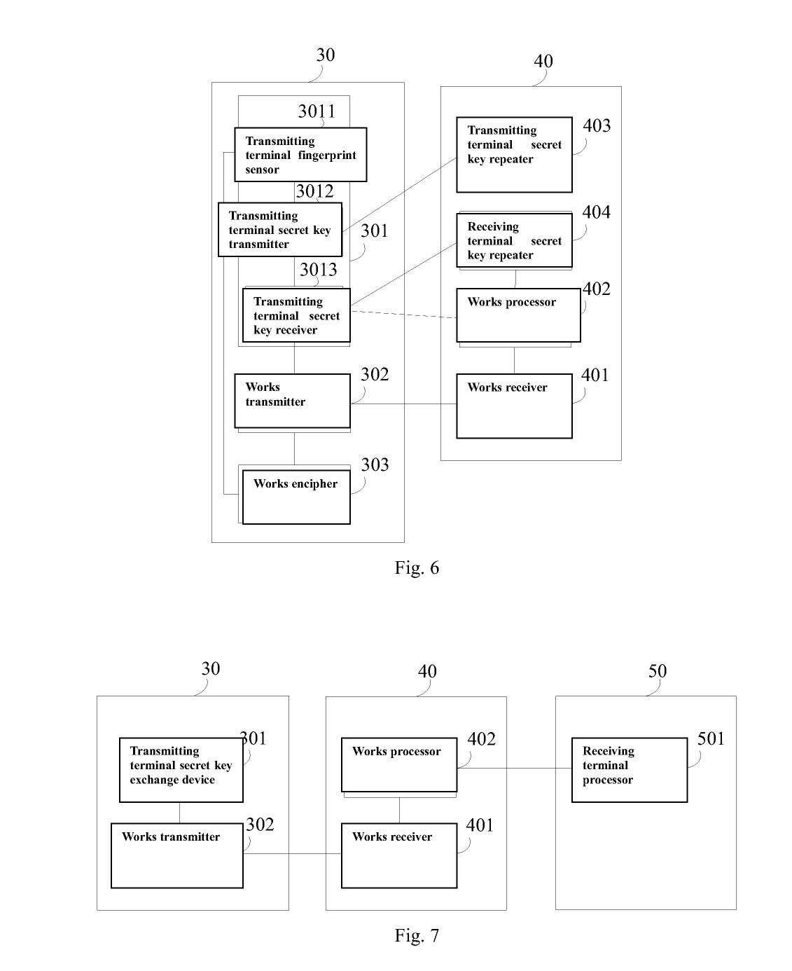

Preferably, as shown in FIG. 6, works transmitting terminal 30 also comprises:

Works encipher 303, respectively connecting to works transmitter 302 and transmitting terminal fingerprint sensor 3011, makes use of fingerprinting private key of works transmitting terminal acquired through transmitting terminal fingerprint sensor 3011 to encrypt the works and acquire the works with private key encryption;

Accordingly, works transmitter 302, specifically connecting to works encipher 303, is used to transmit the works with private key encryption acquired through works encipher 303 to FingerQ Platform 40 after transmitting terminal secret key receiver 3013 receives confirmation message of secret key exchange transmitted by receiving terminal secret key repeater 404 and fingerprinting public key of works receiving terminal 50;

Accordingly, works receiver 401 is specifically used to receive the works with private key encryption transmitted by works transmitter 302;

Accordingly, works processor 402 specifically makes use of fingerprinting public key of works receiving terminal 50 to encrypt the works with private key encryption, so as to acquire and transmit the works with public and private key encryption to works receiving terminal 50.

Preferably, as shown in FIG. 7, the system also comprises: works receiving terminal 50, connection between works receiving terminal 50 and FingerQ Platform 40;

Wherein, works receiving terminal 50 comprises:

Receiving terminal processor 501 connecting to works processor 402 is used to receive encrypted works transmitted by works processor 402, decrypt the encrypted works, acquire and display decrypted works.

It needs to be noted that, various types of equipment in the embodiments of this invention are connected in wired mode, wireless mode or other ways, which can be set according to actual conditions of application and should prescribe no limit to this.

For the said works transmitting system in the embodiment of this invention, works transmitting terminal exchanges secret key with works receiving terminal through FingerQ Platform, which encrypts the works at works transmitting terminal and transmits encrypted works to works receiving terminal, so that the works will not easily be acquired by a third party; moreover acquired works is encrypted that the works can be well protected with high degree of safety.

It needs to be noted that: the works transmitting system provided in above embodiment is only illustrated according to the above division of function modules, but in actual application, it is allowed to achieve the above function distribution by different function modules according to actual needs, i.e. dividing internal structure of equipment into different function modules to achieve all or part of functions described above. In addition, the works transmitting system and works transmitting process provided in the above embodiments belong to the same idea, whose detailed process of realization is in the embodiments, not covered here again.

The serial number of above embodiments of this invention is only for description, not representing merit ranking of the embodiments.

Ordinary technicians in this field can comprehend that all or parts of the steps to realize above embodiments can be achieved through hardware, or be achieved in the way that relevant program instructs relevant hardware, said program can be stored in a type of readable storage medium of computer, which comprises read-only memory, magnetic disk or optical disk, etc.

Described above solely for the purpose of the present invention are preferred embodiments only, not intended to limit the present invention, where any modifications made within the spirit and principle of the present invention, equivalent substitutions, and improvements, etc., should be included in the protection of the invention range.

What is claimed is:

1. A method for transmitting works, comprises:
exchanging a secret key between a works transmitting terminal and a works receiving terminal through a FingerQ Platform;
transmitting, said works transmitting terminal, works to said FingerQ Platform, which encrypts the works, acquiring and transmitting the decrypted works to said works receiving terminal.

2. The method according to claim 1, which further comprising:
extracting, by said works transmitting terminal, the fingerprint information of the user corresponding to said works transmitting terminal, acquiring a fingerprinting public key and a fingerprinting private key of said works transmitting terminal according to user's fingerprint information corresponding to said works transmitting terminal;
transmitting, by said works transmitting terminal, a secret key exchange request and a fingerprinting public key of said works transmitting terminal to works receiving terminal through said FingerQ Platform;
receiving, by said works transmitting terminal, the confirmation message of the secret key exchange and the fingerprinting public key of said works transmitting terminal through said FingerQ Platform.

3. The method according to claim 2, which further comprising:
transmitting, by said works transmitting terminal, the works to said FingerQ Platform, which utilizes a fingerprinting public key of said works receiving terminal, acquiring and transmitting the works with public key encryption to said works receiving terminal.

4. The method according to claim 3, which further comprising:
utilizing, by said works transmitting terminal, the fingerprinting private key of said works transmitting terminal to encrypt works, acquiring the works with private key encryption;
transmitting, by said works transmitting terminal, the works with a private key encryption to FingerQ Platform, which utilizes a public key of works receiving terminal to encrypt the works with said private key encryption, acquiring the works with said public and private key encryptions and transmitting the works to said works receiving terminal.

5. The method according to claim 1, which further comprising:
receiving and decrypting, by said works receiving terminal, the works with encryption, acquiring and displaying decrypted works.

6. A system for transmitting works comprises: a works transmitting terminal connected with a FingerQ Platform;
wherein, said works transmitting terminal comprises:
a transmitting terminal secret key exchanging device connected to said FingerQ Platform used to exchange secret key with works receiving terminal through said FingerQ Platform;
a works transmitter connected to said transmitting terminal secret key exchanging device used to transmit the works to said FingerQ Platform after transmitting terminal secret key exchanging device exchanged the secret key with works receiving terminal through said FingerQ Platform;
wherein, said FingerQ Platform comprises:
a works receiver connecting to said works transmitter used to receive the works which said works transmitter transmits;
a works processor connecting to said works receiver used to encrypt the works which said works receiver receives, to acquire and to transmit the encrypted works to said works receiving terminal.

7. The system according to claim 6, characterized in that said transmitting terminal secret key exchanging device comprises:
a transmitting terminal fingerprint sensor used to extract the fingerprint information of the user corresponding to said works transmitting terminal, acquiring the fingerprinting public key and fingerprinting private key of said works transmitting terminal according to user's fingerprint information corresponding to said works transmitting terminal;
a transmitting terminal secret key transmitter connected to said transmitting terminal fingerprint sensor used to transmit the secret key exchange request and fingerprinting public key of said works transmitting terminal to said FingerQ Platform after said transmitting terminal fingerprint sensor acquired the fingerprinting public key and fingerprinting private key of said works transmitting terminal;
said FingerQ Platform further comprising:
a transmitting terminal secret key repeater connected to transmitting terminal secret key transmitter used to receive the secret key exchange request and fingerprinting public key of said works transmitting terminal transmitted by said transmitting terminal secret key transmitter, and then to transmit the secret key exchange request and fingerprinting public key of said works transmitting terminal to said works receiving terminal;
a receiving terminal secret key repeater connected to said works transmitting terminal used to receive the confirmation message of secret key exchange transmitted by said works receiving terminal and fingerprinting public key of said works receiving terminal, which being transmitted to said works transmitting terminal;
said transmitting terminal secret key exchanging device further comprising:
a transmitting terminal secret key receiver connected to said works transmitter and said receiving terminal secret key repeater used to receive the confirmation message of secret key exchange transmitted by said receiving terminal secret key repeater and fingerprinting public key of said works receiving terminal;
said works transmitter, specifically connected to said transmitting terminal secret key receiver used to transmit said works to said FingerQ Platform after said transmitting terminal secret key receiver having received the confirmation message of secret key exchange transmitted by said receiving terminal secret key repeater and fingerprinting public key of said works receiving terminal.

8. The system according to claim 7, characterized in that said works processor connects to said receiving terminal secret key repeater or said transmitting terminal secret key receiver, specifically utilizing the fingerprinting public key of works receiving terminal acquired by said receiving terminal secret key repeater or said transmitting terminal secret key receiver to encrypt the works, acquiring and transmitting the works with public key encryption to said works receiving terminal.

9. The system according to claim 8, characterized in that said works transmitting terminal further comprising:
A works encipher, connected to said works transmitter and said transmitting terminal fingerprint sensor, respectively, utilizing the fingerprinting private key of works transmitting terminal acquired by said transmitting terminal fingerprint sensor to encrypt the works and acquiring the works with the private key encryption;
said works transmitter, specifically connected to said works encipher, used to transmit the works with the private key encryption acquired by said works encipher to said FingerQ Platform after said transmitting terminal secret key receiver having received the confirmation message of secret key exchange transmitted by said receiving terminal secret key repeater and the fingerprinting public key of said works receiving terminal.
said works receiver specifically used to receive the works with the private key encryption transmitted by said works transmitter;
said works processor, specifically utilizing the fingerprinting public key of said works receiving terminal to encrypt the works with the private key encryption, acquiring and transmitting the works with public and private key encryption to said works receiving terminal.

10. The system according to claim 6, characterized in that said system further comprising: said works receiving terminal connected to said FingerQ Platform;
wherein, said works receiving terminal comprising:
a receiving terminal processor connected to said works processor used to receive the encrypted works transmitted by said works processor, to decrypt the encrypted works, to acquire and to display the decrypted works.
